(19) United States
(12) Patent Application Publication
(10) Pub. No.: US 2018/0165764 A1
(43) Pub. Date: Jun. 14, 2018

(54) SYSTEMS, DEVICES, AND METHODS FOR GENERATING PERSONALIZED ELECTRONIC DOCUMENTS

(71) Applicant: Wal-Mart Stores, Inc., Bentonville, AR (US)

(72) Inventors: Sunil K. Pati, Bentonville, AR (US); Bradley Joseph Kieffer, Rogers, AR (US); Eytan Daniyalzade, San Francisco, CA (US); Prasanna Rajendran, Bentonville, AR (US); Berk Atikoglu, San Francisco, CA (US); Nitin Kaulavkar, Bangalore (IN); Kyle Harmon, Bentonville, AR (US); David Martin Nelms, Rogers, AR (US)

(21) Appl. No.: 15/423,535

(22) Filed: Feb. 2, 2017

(30) Foreign Application Priority Data
Dec. 12, 2016 (IN) 201611042318

(51) Int. Cl. G06Q 40/04; G06Q 20/32; G06Q 20/02

(52) U.S. Cl. CPC G06Q 40/04; G06Q 20/02; G06Q 20/3224

(57) ABSTRACT

Methodologies, systems, and computer-readable media provided for a system for generating personalized electronic documents and verifying user identity are discussed. The system includes a server that receives personalized order details from an application on a mobile electronic device and generates a personalized electronic document for a user. The system also includes a broker system that receives a location identifier and user identification data from the mobile application and transmits a notification to the mobile electronic device when an order associated with the personalized electronic document is processed. The system also includes a computing device near a machine-readable code that can receive user identification data, retrieve the order, and initiate processing of the order using the personalized electronic document.

### RELATED APPLICATIONS

This application claims priority to Indian Patent Application No. 201611042318 entitled “SYSTEMS, DEVICES, AND METHODS FOR GENERATING PERSONALIZED ELECTRONIC DOCUMENTS,” filed on Dec. 12, 2016, the content of which is hereby incorporated by reference in its entirety.

### BACKGROUND

Various types of online orders and electronic transactions can be placed and processed using electronic devices. Processing these orders sometimes requires the use of order details specific to an individual.

### SUMMARY

Embodiments of the present invention utilize a mobile application in concert with a broker system to generate personalized electronic documents and verify a user's identity for financial services transactions. For example, using the mobile application, personalized electronic documents can be generated and a financial services transaction can be initiated prior to the user entering a physical facility for the transaction, thus reducing the time it takes to generate such documents and complete transactions once the user is within the facility.

In one embodiment, a system for generating personalized electronic documents and verifying user identity for financial services transactions includes a server configured to execute a personalized order generation module to receive personalized order details over a network from an application executing on a mobile electronic device associated with a user. The personalized order generation module also generates a personalized electronic document for the user based, at least in part, on the personalized order details. The system also includes a broker computing system configured to execute a user identification module to receive a location identifier and user identification data from the application and transmit a notification to the mobile electronic device in response to an order associated with the personalized electronic document being processed. The location identifier is determined in response to the mobile electronic device scanning a machine readable code. The system also includes a computing device located in proximity to the machine-readable code that is configured to execute a user check-in module. The user check-in module is configured to receive the user identification data from the user identification module, retrieve the order associated with the personalized electronic document from the personalized order generation module following receipt of the user identification data, and initiate processing of the order associated with the personalized electronic document.

In another embodiment, a system for generating personalized electronic documents and verifying user identity for financial services transactions includes a server configured to execute a personalized order generation module to receive personalized order details associated with a user over a network and to generate a personalized electronic document for the user based, at least in part, on the personalized order details. The system also includes a broker computing system configured to execute a user identification module. The user identification module receives a location identifier and user identification data from an application executing on the mobile electronic device and transmits a notification to the mobile electronic device in response to an order associated with the personalized electronic document being processed. The system also includes a computing device located in proximity to the machine-readable code that is configured to execute a user check-in module. The user check-in module receives the user identification data from the user identification module, retrieves the order associated with the personalized electronic document from the personalized order generation module following receipt of the user identification data, and initiates processing of the order associated with the personalized electronic document.

In another embodiment, a method for generating personalized electronic documents and verifying user identity for financial services transactions includes receiving, at a personalized order generation module executed by a server, personalized order details over a network from an application executing on a mobile electronic device associated with a user. The method also includes generating a personalized electronic document for the user via the personalized order generation module based, at least in part, on the personalized order details. The method also includes providing a machine readable code configured to transmit a location identifier to the electronic device in response to being scanned by the electronic device. The method further includes receiving from the application, at a user identification module executed by a broker computing system, the location identifier and user identification data. The method also includes receiving, at a user check-in module, the user identification data from the user identification module. The method additionally includes retrieving an order associated with the personalized electronic document from the personalized order generation module following receipt of the user identification data. The method also includes initiating processing of the order associated with the personalized electronic document and transmitting a notification to the mobile electronic device from the user identification module in response to an order associated with the personalized electronic document being processed.

Additional combinations and/or permutations of the above examples are envisioned as being within the scope of the present disclosure. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The skilled artisan will understand that the drawings are primarily for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present invention will be more fully understood from the following description of exemplary embodiments when read together with the accompanying drawings, in which:

FIG. 1 is a flowchart illustrating an exemplary method for generating personalized electronic documents and verifying user identity for financial services transactions, according to an exemplary embodiment.

FIG. 2 is a flowchart illustrating another exemplary method for generating personalized electronic documents and verifying user identity for financial services transactions, according to an exemplary embodiment.

FIG. 3 is a diagram of an exemplary network environment suitable for a distributed implementation of an exemplary embodiment.

FIG. 4 is a block diagram of an exemplary computing device that can be used to perform exemplary processes in accordance with an exemplary embodiment.

### DETAILED DESCRIPTION

Following below are more detailed descriptions of various concepts related to, and embodiments of, inventive methods, apparatus, and systems for generating personalized electronic documents and verifying user identity for financial services transactions. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means “includes but is not limited to”, the term “including” means “including but not limited to”. The term “based on” means “based at least in part on”.

In accordance with some embodiments of the present invention, methodologies, systems, apparatus, and non-transitory computer-readable media are described herein to facilitate generating personalized electronic documents and verifying user identity for financial services transactions. In exemplary embodiments, a personalized order generation module receives personalized order details relating to a financial services transaction. The personalized order details can be received, in some embodiments, from an application executing on a user's mobile electronic device. Once the personalized order details are received, the personalized order generation module generates a personalized electronic document for the user that can be used to initiate and process the desired financial services transaction. In some embodiments, the user can provide an electronic signature or some other identification code or password using the mobile application to verify the user's identity. In exemplary embodiments, the user can create an online account that includes the user's personal information, financial information, or any other personalized information that may be used in generating personalized electronic documents or verifying user identity for financial services transactions. In some embodiments, a secondary form of authentication, such as a PIN, touch ID, or electronic signature may be required in order to generate the personalized electronic document or to process the transaction and may be received through the mobile application.

In some embodiments, once the user arrives at a check-in station where the user can complete the order, the user's mobile electronic device can communicate with a broker computing system to verify the user's identity and determine the user's location. In some embodiments, the mobile electronic device can scan a computer readable code at the check-in location in order to retrieve a location identifier indicating where the user wishes to complete the order. The broker computing system can parse the location data received from the mobile electronic device to determine the user's location and can execute a user identification module in order to verify the user's identity. Once the user's identity has been verified, the user identification module can transmit the user's identification data to a user check-in module that is executed by a computing device located near the computer-readable code. This user check-in module retrieves the appropriate order associated with the personalized electronic document from the personalized order generation module, based on the user identification data. The user check-in module initiates processing of the order associated with the personalized electronic document, and the user identification module transmits a notification to the user's mobile application when the order has been processed (e.g. when a money transfer has been completed to a third party or the individual's account has been credited with incoming funds).

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

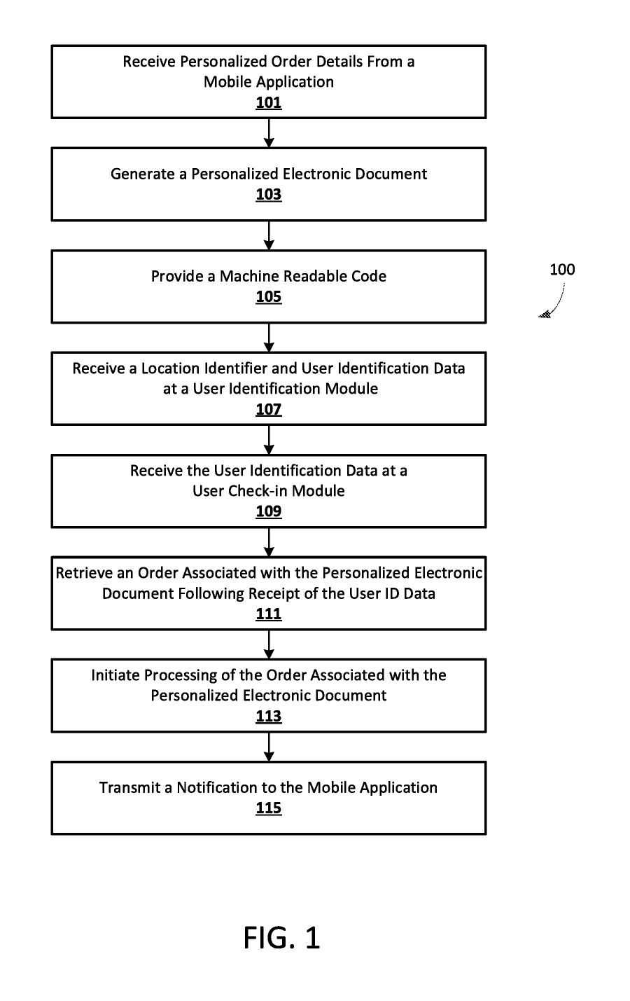

FIG. 1 is a flowchart illustrating an exemplary method 100 for generating personalized electronic documents and verifying user identity for financial services transactions, according to an exemplary embodiment. It will be appreciated that the method is programmatically performed by one or more computer-executable processes executing on, or in communication with one or more servers described further below. In step 101, a server executes a personalized order generation module and receives personalized order details over a network from an application executing on a user's mobile electronic device. In some embodiments, the user can transmit the personalized order details to the personalized order generation module using the mobile application in order to initiate generation of a personalized electronic document. In some embodiments, the user has created an online account that includes personal information and the personalized order details.

In step 103, once the personalized order details have been received at the personalized order generation module, the personalized electronic document is generated for the user. The personalized electronic document is generated, at least in part, based on the personalized order details received in step 101. In various embodiments, the personalized electronic document can be generated automatically, or with the help of an individual.

In step 105, a machine readable code, such as a one-dimensional barcode, a two-dimensional barcode, or a matrix barcode, is provided at a particular location. The machine readable code is configured to transmit a location identifier to the user's mobile electronic device in response to the machine readable code being scanned by the mobile electronic device. In some embodiments, the user can scan the machine readable code using a camera of the mobile electronic device. In some embodiments, Bluetooth or other wireless technologies can be used in order to provide a location identifier to the user's mobile electronic device. In other embodiments, the machine readable code can be generated on the user's mobile electronic device and scanned by an electronic device located at or near a user check-in module.

In step 107, a user identification module receives the location identifier and user identification data from the application executing on the mobile electronic device. In some embodiments, the user identification module is executed by a broker computing system in order to verify the user's identity. The user identification data and the user's personalized order details can be stored, in some embodiments, using a user account module.

In step 109, a user check-in module receives the user identification data from the user identification module. The user check-in module can be executed by a computing device located in proximity to the machine-readable code.

In step 111, the user check-in module retrieves an order associated with the personalized electronic document from the personalized order generation module after receipt of the user identification data in step 109. In some embodiments, the personalized order generation module can receive a number of orders from different users, and once the user check-in module knows the identity of the user, it can retrieve the appropriate order from the personalized order generation module.

In step 113, the user check-in module initiates processing of the order associated with the personalized electronic document. In some embodiments, the user has already provided financial information using the user's online account that can be accessed via the application executing on the mobile electronic device. The order can be processed, in some embodiments, using the user check-in module or some other transaction processing terminal. In other embodiments, the processing of the order is performed by a third party entity separate from an entity controlling operation of the server and the broker system.

In step 115, the user identification module executed by a broker computing system transmits a notification to the mobile electronic device once the order associated with the personalized electronic document is processed. In some embodiments, the notification includes a receipt for the order and an explanation of the financial services transaction.

In some embodiments, additional authentication measures, such as a digital signature or PIN, are needed in order to generate the personalized electronic document and verify user identity. In such embodiments, one or more digital signatures associated with the user can be stored at a database or storage location. The digital signature can be retrieved to generate the personalized electronic document and verify user identity, and the digital signature can be received via the application executing on the mobile electronic device.

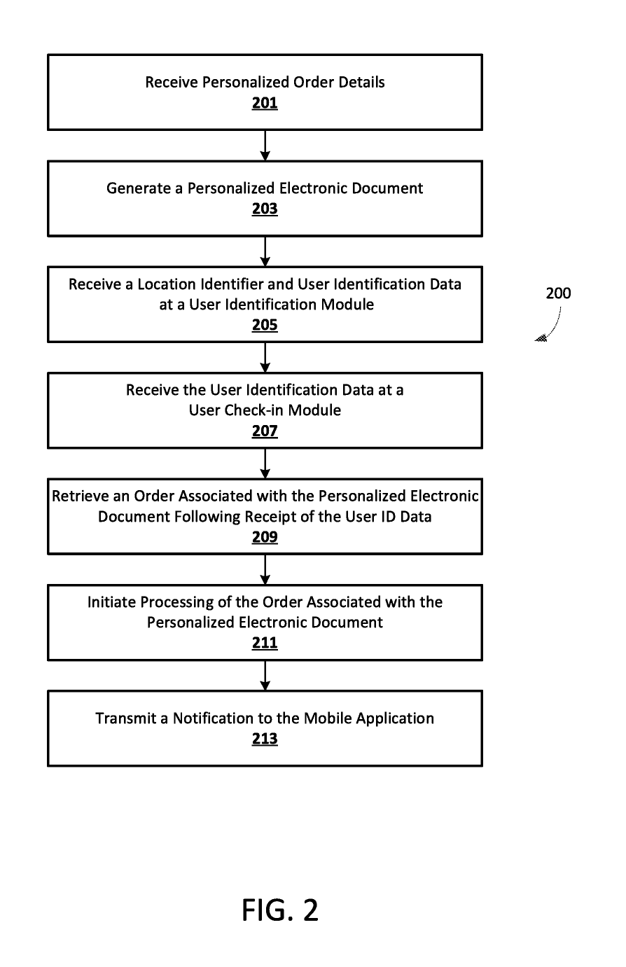

FIG. 2 is a flowchart illustrating another exemplary method 200 for generating personalized electronic documents and verifying user identity for financial services transactions, according to an exemplary embodiment. It will be appreciated that the method is programmatically performed by one or more computer-executable processes executing on, or in communication with one or more servers described further below. In step 201, a server executes a personalized order generation module and receives personalized order details over a network. In some embodiments, the personalized order details can be received through an online account associated with a user. In some embodiments, the user's online account includes user identification data as well as the personalized order details.

In step 203, the personalized order details have been received at the personalized order generation module, the personalized order generation module generates a personalized electronic document for the user based, at least in part, on the personalized order details. This electronic document can be used to complete and process an order, such as a financial transaction, in some embodiments.

In step 205, a user identification module executing on a broker computing system receives a location identifier and user identification data from an application executing on a user's mobile electronic device. The location identifier identifies a location where the user wishes to complete the order or financial transaction, and the user identification data is used to verify the user's identity. In some embodiments, the user has created an online account that includes user identification data, and the user identification data can be transmitted to the user identification module from the online account or from the mobile electronic device. In some embodiments, the user's mobile electronic device can determine the location identifier by scanning a machine readable code at or near a user check-in module, as discussed above, or using Bluetooth or other wireless technologies.

In step 207, a computing device located in proximity to the machine-readable code executes a user check-in module and receives the user identification data from the user identification module. Once the user check-in module receives the user identification data, it can retrieve the appropriate order in step 209 associated with the personalized electronic document from the personalized order generation module.

In step 211, the user check-in module initiates processing of the order associated with the personalized electronic document. In some embodiments, the user has already provided financial information via the user's online account, and that account can be accessed via the application executing on the mobile electronic device. The order can be processed, in some embodiments, using the user check-in module or some other financial transaction processing terminal. In other embodiments, the processing of the order is performed by a third party entity separate from an entity controlling operation of the server and the broker system.

In step 215, the user identification module executed by a broker computing system transmits a notification to the mobile electronic device once the order associated with the personalized electronic document is processed. In some embodiments, the notification includes a receipt for the order and an explanation of the financial services transaction.

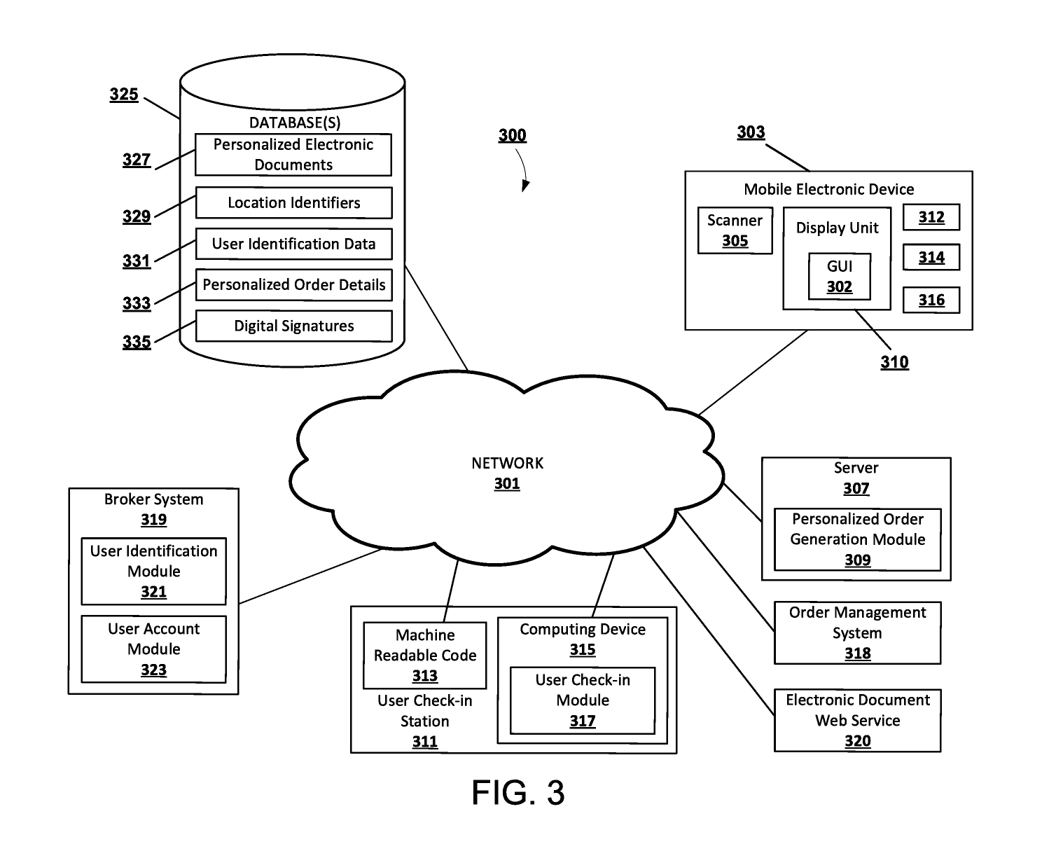

FIG. 3 illustrates a network diagram depicting a system 300 suitable for a distributed implementation of an exemplary embodiment. The system 300 can include a network 301, mobile electronic device 303, server 307, order management system 318, computing device 315, machine-readable code 313, broker computing system 319, and a database 325. As will be appreciated, various distributed or centralized configurations may be implemented without departing from the scope of the present invention. In exemplary embodiments, server 307 can store a personalized order management module 309, computing device 315 can store a user check-in module 317, and broker computing system 319 can store a user identification module 321 and a user account module 323, each of which can implement one or more of the processes described herein with reference to FIGS. 1-2, or portions thereof. It will be appreciated that the module functionality may be implemented as a greater or lesser number of modules than illustrated and that the same server, computing device, and broker computing system could also host multiple modules. The database 325 can store the personalized electronic documents 327, location identifiers 329, user identification data 331, personalized order details 333, and digital signatures 335, as discussed herein. In some embodiments, the order management system 318 can store various types of orders, and the personalized order generation module 309 can communicate with the order management system 318 to retrieve the appropriate orders associated with the personalized electronic documents. In some embodiments, the personalized order generation module 309 can communicate with an electronic document web service 320 in order to generate the personalized electronic documents described herein.

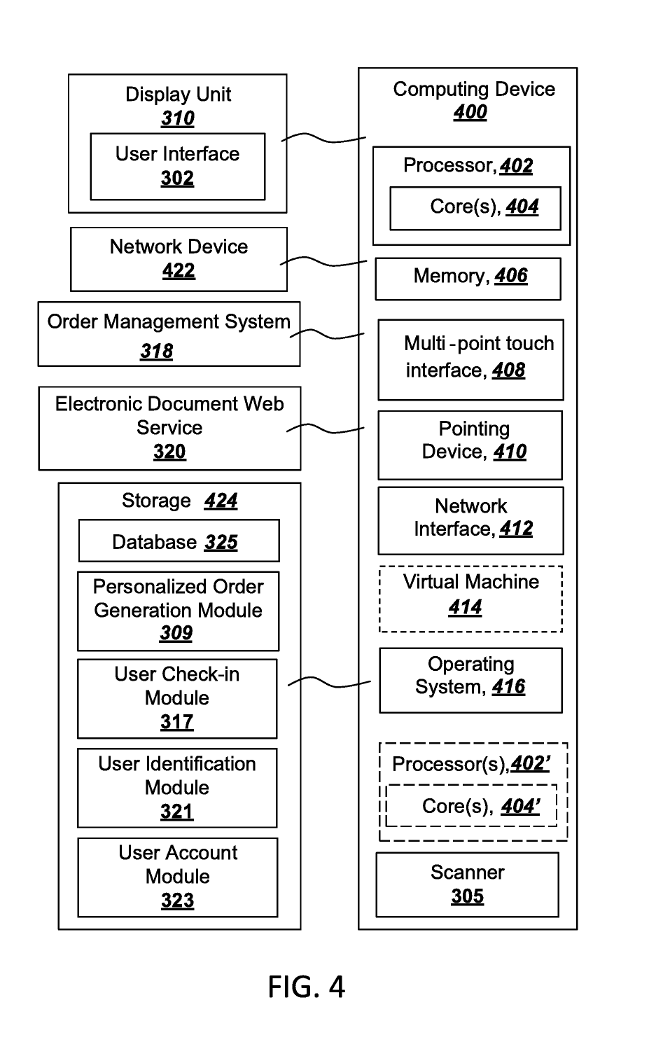

In exemplary embodiments, the mobile electronic device 303 may include a display unit 310, which can display a GUI 302 to a user of the mobile electronic device 303. The mobile electronic device can also include a memory 312, processor 314, and a wireless interface 316, as well as a scanner 305 configured to scan machine readable codes. In some embodiments, the mobile electronic device 303 may include, but is not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, smartphones, tablets, netbooks, and the like. The electronic device 300 may include some or all components described in relation to computing device 400 shown in FIG. 4.

The mobile electronic device 303 may connect to a network 301 via a wired or wireless connection. The mobile electronic device 303 may include one or more applications such as, but not limited to, a personalized electronic document application, a web browser, a sales transaction application, an object reader application, and the like. In some embodiments, the computing device 315 and the machine readable code 313 are both located at a user check-in station 311 and the mobile electronic device and/or the user can interact with the computing device 315 executing the user check-in module to complete a financial services transaction.

In exemplary embodiments, the mobile electronic device 303, server 307, order management system 318, electronic document web service 320, computing device 315, machine readable code 313, broker system 319, and database 325 may be in communication with each other via the communication network 301. The communication network 301 may include, but is not limited to, the Internet, an intranet, a LAN (Local Area Network), a WAN (Wide Area Network), a MAN (Metropolitan Area Network), a wireless network, an optical network, and the like. In one embodiment, the mobile electronic device 303, server 307, computing device 315, machine readable code 313, and broker system 319 can transmit instructions to each other over the communication network 301. In exemplary embodiments, the personalized electronic documents 327, location identifiers 329, user identification data 331, personalized order details 333, and digital signatures 335 can be stored at the database 325 and received at the mobile electronic device 303, server 307, computing device 315, and broker system 319 in response to a service performed by a database retrieval application.

FIG. 4 is a block diagram of an exemplary computing device 400 that can be used in the performance of the methods described herein. The computing device 400 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like.

For example, memory 406 included in the computing device 400 can store computer-readable and computer-executable instructions or software for implementing exemplary embodiments and programmed to perform processes described above in reference to FIGS. 1-2. The computing device 400 also includes processor 402 and associated core 404, and optionally, one or more additional processor(s) 402′ and associated core(s) 404′ (for example, in the case of computer systems having multiple processors/cores), for executing computer-readable and computer-executable instructions or software stored in the memory 406 and other programs for controlling system hardware. Processor 402 and processor(s) 402′ can each be a single core processor or multiple core (404 and 404′) processor.

Virtualization can be employed in the computing device 400 so that infrastructure and resources in the computing device can be shared dynamically. A virtual machine 414 can be provided to handle a process running on multiple processors so that the process appears to be using only one computing resource rather than multiple computing resources. Multiple virtual machines can also be used with one processor.

Memory 406 can be non-transitory computer-readable media including a computer system memory or random access memory, such as DRAM, SRAM, EDO RAM, and the like. Memory 406 can include other types of memory as well, or combinations thereof.

A user can interact with the computing device 400 through a display unit 310, such as a touch screen display or computer monitor, which can display one or more user interfaces 302 that can be provided in accordance with exemplary embodiments. The computing device 400 can also include other I/O devices for receiving input from a user, for example, a keyboard or any suitable multi-point touch interface 408, a pointing device 410 (e.g., a pen, stylus, mouse, or trackpad). The multi-point touch interface 408 and the pointing device 410 can be coupled to the display unit 310. The computing device 400 can include other suitable conventional I/O peripherals. The computing device 400 can also include a scanner 305, such as an optical scanner, that can scan and read a machine readable code, as discussed above.

The computing device 400 can also include one or more storage devices 424, such as a hard-drive, CD-ROM, or other non-transitory computer readable media, for storing data and computer-readable instructions and/or software, such as a personalized order generation module 309, a user check-in module 317, a user identification module 321, and a user account module 323 that can implement exemplary embodiments of the methods and systems as taught herein, or portions thereof. Exemplary storage device 424 can also store one or more databases 325 for storing any suitable information required to implement exemplary embodiments. The databases can be updated by a user or automatically at any suitable time to add, delete, or update one or more items in the databases. Exemplary storage device 424 can store one or more databases 325 for storing the personalized electronic documents 327, location identifiers 329, user identification data 331, personalized order details 333, digital signatures 335, and any other data/information used to implement exemplary embodiments of the systems and methods described herein.

The computing device 400 can also be in communication with an order management system 318 that can store various types of orders. In one embodiment, the order management system 318 can store information relating to multiple financial transaction orders, and the personalized order generation module 309 can communicate with the order management system 318 to retrieve the appropriate orders associated with the personalized electronic documents generated, as discussed above. In some embodiments, the personalized order generation module 309 can communicate with an electronic document web service 320 in order to generate the personalized electronic documents.

The computing device 400 can include a network interface 412 configured to interface via one or more network devices 422 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 412 can include a built-in network adapter, network interface card, PCMCIA network card, card bus network adapter, wireless network adapter, USB network adapter, modem or any other device suitable for interfacing the computing device 400 to any type of network capable of communication and performing the operations described herein. Moreover, the computing device 400 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 400 can run operating system 416, such as versions of the Microsoft® Windows® operating systems, different releases of the Unix and Linux operating systems, versions of the MacOS® for Macintosh computers, embedded operating systems, real-time operating systems, open source operating systems, proprietary operating systems, operating systems for mobile computing devices, or other operating systems capable of running on the computing device and performing the operations described herein. In exemplary embodiments, the operating system 416 can be run in native mode or emulated mode. In an exemplary embodiment, the operating system 416 can be run on one or more cloud machine instances.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A system for generating personalized electronic documents and verifying user identity for financial services transactions, the system comprising:
(i) a server configured to execute a personalized order generation module that when executed:
(a) receives personalized order details over a network from an application executing on a mobile electronic device associated with a user; and
(b) generates a personalized electronic document for the user based, at least in part, on the personalized order details;
(ii) a broker computing system configured to execute a user identification module that when executed:
(a) receives from the application executing on the mobile electronic device a location identifier and user identification data, wherein the location identifier is determined in response to the mobile electronic device scanning a machine readable code; and
(b) transmits a notification to the mobile electronic device in response to an order associated with the personalized electronic document being processed; and
(iii) a computing device located in proximity to the machine-readable code that is configured to execute a user check-in module that when executed:
(a) receives the user identification data from the user identification module;
(b) retrieves the order associated with the personalized electronic document from the personalized order generation module following receipt of the user identification data; and
(c) initiates processing of the order associated with the personalized electronic document.

2. The system of claim 1, further comprising a user account module configured to store the user identification data and the personalized order details.

3. The system of claim 1, wherein the machine readable code includes a one-dimensional barcode, a two-dimensional barcode, or a matrix barcode.

4. The system of claim 1, wherein the notification includes a receipt for the order.

5. The system of claim 1, wherein a digital signature associated with the user is stored in a database and retrieved to process the order associated with the personalized electronic document.

6. The system of claim 1, wherein the processing of the order is performed by a third party entity separate from an entity controlling operation of the server and broker system.

7. A system for generating personalized electronic documents and verifying user identity for financial services transactions, the system comprising:
(i) a server configured to execute a personalized order generation module that when executed:
(a) receives personalized order details associated with a user over a network; and
(b) generates a personalized electronic document for the user based, at least in part, on the personalized order details;
(ii) a broker computing system configured to execute a user identification module that when executed:
(a) receives from an application executing on the mobile electronic device a location identifier and user identification data; and
(b) transmits a notification to the mobile electronic device in response to an order associated with the personalized electronic document being processed; and
(iii) a computing device located in proximity to the machine-readable code that is configured to execute a user check-in module that when executed:
(a) receives the user identification data from the user identification module;
(b) retrieves the order associated with the personalized electronic document from the personalized order generation module following receipt of the user identification data; and
(c) initiates processing of the order associated with the personalized electronic document.

8. The system of claim 7, wherein the processing of the order is performed by a third party entity separate from an entity controlling operation of the server and broker system.

9. A method for generating personalized electronic documents and verifying user identity for financial services transactions, the method comprising:
receiving, at a personalized order generation module executed by a server, personalized order details over a network from an application executing on a mobile electronic device associated with a user;
generating a personalized electronic document for the user via the personalized order generation module based, at least in part, on the personalized order details;
providing a machine readable code configured to transmit a location identifier to the electronic device in response to being scanned by the electronic device;
receiving from the application executing on the mobile electronic device, at a user identification module executed by a broker computing system, the location identifier and user identification data;
receiving, at a user check-in module, the user identification data from the user identification module;
retrieving an order associated with the personalized electronic document from the personalized order generation module following receipt of the user identification data;
initiating processing of the order associated with the personalized electronic document; and
transmitting a notification to the mobile electronic device from the user identification module in response to an order associated with the personalized electronic document being processed.

10. The method of claim 9, further comprising storing, via a user account module, the user identification data and the personalized order details.

11. The method of claim 9, wherein the machine readable code includes a one-dimensional barcode, a two-dimensional barcode, or a matrix barcode.

12. The method of claim 9, wherein the notification includes a receipt for the order.

13. The method of claim 9, further comprising:
storing a digital signature associated with the user in a database; and
retrieving the digital signature to process the order associated with the personalized electronic document.

14. The method of claim 9, wherein the processing of the order is performed by a third party entity separate from an entity controlling operation of the server and the broker system.

15. A non-transitory machine readable medium storing instructions executable by a processing device, wherein execution of the instructions causes the processing device to implement a method for generating personalized electronic documents and verifying user identity for financial services transactions, the method comprising:
receiving, at a personalized order generation module executed by a server, personalized order details over a network from an application executing on a mobile electronic device associated with a user;
generating a personalized electronic document for the user via the personalized order generation module based, at least in part, on the personalized order details;
providing a machine readable code configured to transmit a location identifier to the electronic device in response to being scanned by the electronic device;
receiving from the application executing on the mobile electronic device, at a user identification module executed by a broker computing system, the location identifier and user identification data;
receiving, at a user check-in module, the user identification data from the user identification module;
retrieving an order associated with the personalized electronic document from the personalized order generation module following receipt of the user identification data;
initiating processing of the order associated with the personalized electronic document; and
transmitting a notification to the mobile electronic device from the user identification module in response to an order associated with the personalized electronic document being processed.

16. The non-transitory machine readable medium of claim 15, wherein execution of the instructions further causes the processing device to store, via a user account module, the user identification data and the personalized order details.

17. The non-transitory machine readable medium of claim 15, wherein the machine readable code includes a one-dimensional barcode, a two-dimensional barcode, or a matrix barcode.

18. The non-transitory machine readable medium of claim 15, wherein the notification includes a receipt for the order.

19. The non-transitory machine readable medium of claim 15, wherein execution of the instructions further causes the processing device to:
store a digital signature associated with the user in a database; and
retrieve the digital signature to process the order associated with the personalized electronic document.

20. The non-transitory machine readable medium of claim 15, wherein the processing of the order is performed by a third party entity separate from an entity controlling operation of the server and the broker system.
